(19) United States
(12) Patent Application Publication
(10) Pub. No.: US 2015/0161644 A1
(43) Pub. Date: Jun. 11, 2015

(54) METHOD AND APPARATUS FOR MANAGING ACCOUNT OPTIONS

(71) Applicant: Verizon Patent and Licensing Inc., Basking Ridge, NJ (US)

(72) Inventors: Vijay BAMANE, Irving, TX (US); Tushar DAVE, Germantown, MD (US); Senthil MUTHUSAMY, Lewisville, TX (US); Premjith PULLAMPLAVIL, Carrollton, TX (US)

(73) Assignee: Verizon Patent and Licensing Inc., Basking Ridge, NJ (US)

(21) Appl. No.: 14/099,015

(22) Filed: Dec. 6, 2013

(51) Int. Cl. G06Q 30/02

(52) U.S. Cl. CPC G06Q 30/0226

(57) ABSTRACT

An approach for account management includes retrieving a current account option selected by a subscriber for a service account, applying a rule to determine a recommended account option for reducing a cost for the service account, wherein the rule provides criteria for selecting the recommended account option from among an upgrade and renewal option, a right-sizing option, a loyalty offer option, or a combination thereof, and generating a customer service user interface for presenting at least one of: cost comparison information for the current account option and the recommended account option, a control element for ordering the recommended account option, and information for discussing the recommended option with the subscriber.

### BACKGROUND INFORMATION

Service providers offer a complex assortment of voice, video, and data services into a a growing and increasingly fragmented market. The widespread adoption of Internet-based subscription services has led to increasingly complicated product configurations across a wide range of network infrastructure and consumer premise equipment. Pricing pressure from competitors is leading to the adoption of more flexible product packages with an assortment of features, pricing promotions, upgrades, and discount programs. Simultaneously, the range of products on offer and services is continually changing. Consumers of such products are able to shop similar offerings from competitors and perform price evaluations to obtain better deals. Faced with a rapidly changing marketplace and an evolving portfolio of products, a service provider must be able to control the presentation of account options (e.g., upgrades, renewals, promotions, discounts, etc.) when interacting with customers while also empowering customer service representatives to negotiate with customers.

Based on the foregoing, there is a need for a method of managing account options when customer service representatives are interacting with customers.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 illustrates a system capable of account options management, according to an exemplary embodiment;

FIG. 2 illustrates an account options platform, according to an exemplary embodiment;

FIGS. 3A through 3F illustrate flowcharts of various processes for account options management, according to an exemplary embodiment;

FIG. 4 illustrates an upgrade and renewal tab of a customer relationship management (CRM) application, according to an exemplary embodiment.

FIG. 5 illustrates a right-sizing tab of a CRM application, according to an exemplary embodiment;

FIG. 6 illustrates a loyalty offer tab of a CRM application, according to an exemplary embodiment;

FIGS. 7A through 7C illustrate an account cost display of a CRM application, according to an exemplary embodiment;

FIGS. 8A through 8C illustrate a dialog box of a CRM application, according to an exemplary embodiment;

FIG. 9 is a diagram of a computer system that can be used to implement various exemplary embodiments; and

FIG. 10 is a diagram of a chip set that can be used to implement various exemplary embodiments.

### DESCRIPTION OF THE PREFERRED EMBODIMENT

An apparatus, method, and software for account options management, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to managing account options for a telecommunications service provider, it is contemplated that these embodiments have applicability to systems operated by different organizations and to other operations wherein account options must be managed.

As used herein, the term “account option” may be used to refer to an existing or modified service that a customer is subscribed to. A modification may include changes to the level or quality of the service as well as removal or addition of features. The term “service” may be used to refer to traditional connectivity services offered by service providers (e.g., voice, video, data connectivity services) as well as various non-traditional or hybrid services (e.g., premium content from third-party vendors). In one embodiment, an account option may also include a modification to a number or type of customer premise equipment (CPE) utilized by a subscriber. CPE may include, for instance, digital adapters, wireless or wireline routers, security devices, storage systems, and content recording systems (e.g., digital video recorders (DVR)). It is contemplated that the set of services offered by a service provider may be changed without affecting the operation of the present disclosure.

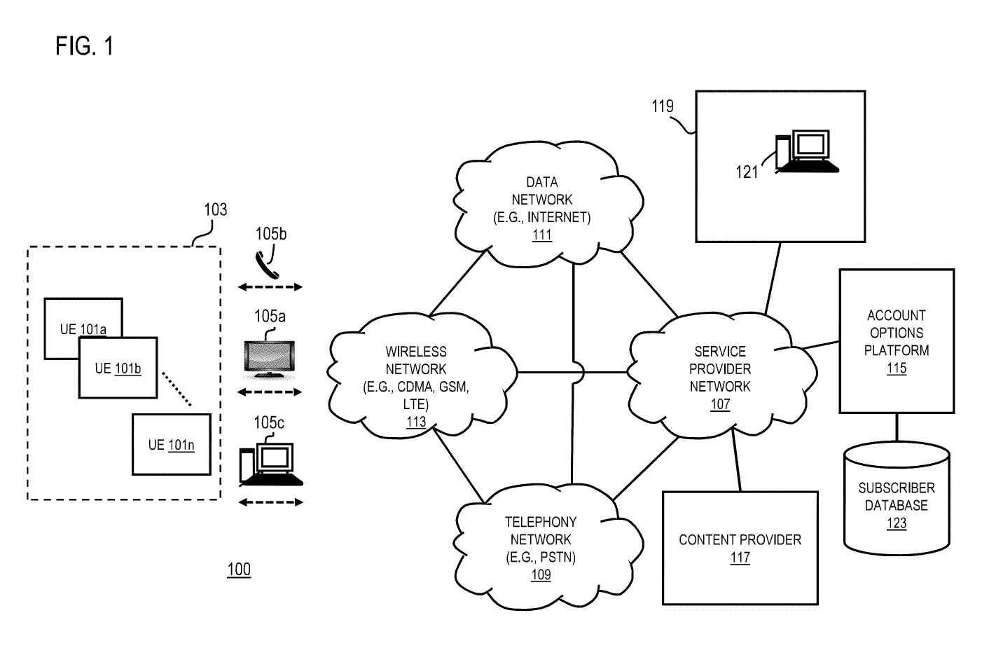

FIG. 1 illustrates a system 100 capable of account options management, according to an exemplary embodiment. As shown in FIG. 1, the system 100 comprises user equipment (UE) 101a-101n (collectively referred to as UE 101) that may be associated with a customer of a service provider. In one embodiment, the UE 101 are located at a customer premises (e.g., the customer premise 103) such that they receive various services 105 from a service provider via networks 107-113. In one embodiment, the services 105 include voice, video and data services. In one embodiment, the account options platform 115 performs an account options management function for a service account of a customer.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

As shown, the system 100 includes the account options platform 115 implemented as, for example, part of the service provider network 107. However, in alternative embodiments, the account options platform 115 could be implemented as any part of the system 100. In one embodiment, the service provider network 107 can interact with one or more other networks, such as a telephony network 109, a data network 111, and/or a wireless network 113. The service provider network 107 can include one or more content providers (e.g., content provider 117) that provide content-related services (e.g., digital video streaming) to the service provider network 107. In one embodiment, content provider 117 can be associated with any part of the system 100, such as the telephony network 109, the data network 111, and the wireless network 113. Additional content providers associated with, for example, the telephony network 109, the data network 111, or the wireless network 113, also can interact with the account options platform 115, the content provider 117 and the UE 101.

For illustrative purposes, the networks 107-113 may be any suitable wireline and/or wireless network, and be managed by one or more service providers. For example, telephony network 109 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 107 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of the system 100. In this manner, networks 107-113 may embody or include portions of a signaling system 7 (SS7) network, or other suitable infrastructure to support control and signaling functions.

A subscriber may subscribe to voice, video, and data services offered by the service provider. For example, a subscriber may receive Internet-based high-definition video service 105a at one or more UE 101 located at the customer premise 103. A subscriber may also receive a digital or analog voice service 105b. For instance, the voice service 105b may be received at any suitable plain old telephone service (POTS) device, facsimile machine, digital adapter, etc., whereas a mobile device (or terminal) may be any cellular phone, radiophone, satellite phone, smart phone, wireless phone, or any other suitable mobile device, such as a PDA, pocket personal computer, tablet, customized hardware, etc. A subscriber may also receive, for example, a high-speed data service 105c. For example, a subscriber may access the Internet or other packet-based network service via one or more UE 101 (e.g., desktop or laptop computers, handheld devices, etc.). For example, the data service may be received at any suitable computing device, such as a VoIP phone, skinny client control protocol (SCCP) phone, session initiation protocol (SIP) phone, IP phone, personal computer, softphone, workstation, terminal, server, etc. In one embodiment, the customer premise 103 is a household. However, it is contemplated that the customer premise 103 may be any, private, business, or public space that receives one or more communication and/or content services from a service provider.

The voice, video, and data services may be delivered over separate networks or a single network. The underlying network infrastructure and protocols may be the same or different for the various services. In one embodiment, the voice, video, and data services are delivered over a packet-based transport network. For example, the voice, video and data services may all be Internet-based services delivered to the customer premise 103 over a high speed or broadband Internet connection. In one embodiment, the services are delivered over a fiber to the home (FTTH) access network. In another embodiment, the voice, video, and data services may be delivered via a broadband connection over a copper-based telephone network (e.g., digital subscriber line (DSL)). Alternatively, the various network services may be delivered over a broadband wireless service (e.g., 4G Long Term Evolution (LTE) network). It is contemplated that the various embodiments of the present disclosure are compatible with any underlying physical and/or data layer technology.

As shown, the service provider may have one or more customer support centers (e.g., customer support center 119) to provide technical, billing, and sales support to its subscribers. Subscribers may contact the service provider via various communication channels (e.g., phone, email, web) to review their service accounts. The support centers (e.g., customer support center 119) may be managed and operated by the service provider or an independent contractor. Customer service representatives may be provided access to the service provider's accounting and billing systems (not shown) via a CRM application executing, or otherwise implemented, at the customer support terminal 121. In one embodiment, the customer support terminals (e.g., customer support terminal 121) may access the service provider's account and billing information systems remotely. In one embodiment, the customer support terminal (e.g., customer support terminal 121) may provide secure access to protect customer records. For example, customer service representatives may be required to complete a logon process or other authentication and authorization procedures.

As mentioned, the customer support terminal 121 may be configured to execute a CRM application. In one embodiment, a customer service representative may log on to the CRM application to access the service account of a subscriber calling the customer support center 119. The CRM application may have a graphical user interface (GUI) that the customer service representative interacts with. In one embodiment, the GUI is a multiple document interface (MDI). For example, the GUI may present a tabbed document interface (TDI). Each window of the MDI may be used to present various aspects of the subscriber's service account. In one embodiment, the CRM application communicates with the account options platform 115. For example, the GUI of the CRM application executing at the customer support terminal 121 may be a GUI part of a web-based application hosted by one or more remote servers (not shown). In one embodiment, the remote servers are cloud-based servers hosting the account and billing information systems of the service provider. The remote servers may also include dedicated servers that are integrated with the internal corporate network of the service provider and obtain data associated with the service accounts from one or more internal databases.

In one embodiment, the account information for the subscribers is stored in a subscriber database 123. The subscriber database 123 may include a subscriber profile (e.g., name, address, account number, device identifiers, etc.) that details various subscriber-specific items. In one embodiment, the subscriber database 123 includes one or more databases of a billing system (not shown). For example, the subscriber database 123 may include a record of the services the subscriber is subscribed to and the monthly rate charge (MRC) at which the subscriber is being billed. As used herein, “monthly rate charge (MRC)” may be used interchangeably with “account cost” to refer to a monthly cost to the subscriber for receiving one or more services via the service provider. The record may also include details on particular service packages that the subscriber is currently enrolled in. For a subscriber with voice service, for example, the record may specify a name of a particular voice service package and the MRC at which the service is being offered to the subscriber. The record may similarly specify a data and video service the subscriber is subscribed to and the MRC at which these services are being offered. In addition, the record may specify a time period for which the subscriber is under a contract to receive the subscribed services and the terms of the contract. For example, the record may include a beginning and ending date of a contract. Alternatively, the record may indicate that the subscriber is not enrolled in a contract and only receives one or more services on a pay-as-you-go term (e.g., month-to-month).

The records of the subscriber database 123 may also include any discounts (e.g., special discounts, rebates, promotions, etc.) that a subscriber is receiving or is eligible for. In one embodiment, the subscriber database 123 may also include information on any special or limited-time offers that the subscriber is receiving or is eligible for. A record may further indicate a time period (e.g., dates) or a duration (e.g., days) for which the special offer is available and an MRC if the subscriber wishes to continue the service beyond a trial period. In one embodiment, the record may further indicate the basis for such special offers including, for example, complimentary limited-period trial period for a particular product.

In addition to the voice, video, and data services, the service provider may also offer subscriptions to third-party products and services. For example, the service provider may serve as an intermediary for various web-based services. The service provider may act as a reseller for the content provider 117. In one embodiment, the content provider 117 may deliver various channels of content via the service provider network 107. For example, the content provider 117 may be a branded producer of premium on-demand or interactive video content. In one embodiment, the content provider 117 may deliver the content to a subscriber under the terms of a wholesale contract between the content provider 117 and the service provider. In turn, the service provider may be responsible for providing billing and support services for the content services. In one scenario, for instance, a subscriber may receive a packaged video service that includes premium video content from the content provider 117. In one embodiment, the account and billing information associated with such third-party services may be stored in the subscriber database 123. In one embodiment, the service provider may generate a single bill that includes all the services the subscriber is receiving, including third-party services for which the service provider is an intermediary.

The service provider may be responsible for developing and promoting the content offerings of third-party vendor as part of a coherent marketing strategy involving cross-branding or cross-promotion of third-party services. In one embodiment, the billing and account information systems of the service provider may manage the pricing and billing of third-party services alongside the service provider's own services. For example, the service provider may offer as a base package an Internet-based digital voice, high-definition video, and data service. In addition, the service provider may offer a suite of content channels from the content provider 117. The content offerings may be packaged into one or more premium packages at an additional cost to the account cost of the base package. The service provider may handle all the billing support for the content provider 117. In one embodiment, the subscriber database 123 may maintain the pricing information for all the services received by a subscriber. The subscriber database 123 may also store subscriber-specific information on product configurations that include combinations of content and voice, video, data services.

In addition to storing subscriber profile data and billing information, the subscriber database 123 may also maintain a record of CPE utilized by subscribers. In one embodiment, the subscriber database 123 may maintain a record of the type and number of devices installed at the customer premise 103. For example, a subscriber record may contain a number of installed set-top boxes (STB). Other CPE may include video recording devices (e.g., DVR), a digital voice adapter, etc. The subscriber database 123 may also maintain a record of the number of subscriber-owned devices at the customer premises that are authorized to receive voice, video or data service. For example, a particular service package may require the subscriber to register devices with the service provider. In one embodiment, the subscriber database 123 may store a device identifier (e.g., model/serial number) for each registered device at the customer premise 103 and thereby control the number of devices eligible to receive a particular service (e.g., video streaming). In one embodiment, the billing information for a subscriber may include a bundled account cost associated with various home networking scenarios. For example, a particular base voice, video, data, package may also include a channel lineup and one or more STB, digital voice adapters, and a limited number of registered devices.

The approach of the system 100 stems, in part, from the recognition that the extensive range of service, content, and equipment offerings produces complex price structures. Alongside the possible pre-packaged service combinations, various optional and short-term incentive offers must also be routinely negotiated on a per-subscriber basis. Customer service representatives must be equipped with information and tools to answer questions from subscribers calling to ask about recent price changes or to simply better understand the services they are being billed for. To answer such queries successfully, customer service representatives require significant autonomy in order to negotiate and present prices, discounts, and promotions based on the subscriber's needs and concerns. For instance, customer service representatives must be able to present one or more account options based on various aspects of the subscriber's profile and his or her individual budgetary concerns. Different subscribers have different needs. For example, subscribers may be distinguished in terms of the duration of their contracts, the overall amount of time they have been a customer of the service provider, the range of services that they are currently subscribed to, as well as the range of services that they may be interested in based on their current subscriptions and viewing habits.

In addition to providing more autonomy to customer service representatives, the service provider must be able to control its revenue strategy in order that it is coherent across the full range of its services and markets that it operates in. Specifically, the use of promotions, discounts, or other customer satisfaction and retention tools must be in alignment with the broader revenue strategy. Currently, a significant drain on a service provider's revenue is due to the excessive usage of so-called “bottom-of-the-line” discounts. As used herein, the term “bottom-of-the-line discounts” may be used interchangeably with “loyalty offers” to refer to an overall price reduction that is applied across the board to a customer's MRC or account cost. Such a discount is applied to reduce the total cost of all subscribed services, content, and/or equipment. For example, a ten percent bottom-of-the-line discount to a subscriber's bill may be reflected in a ten percent reduction of the MRC for the charges associated with all the services. In the short-term, such discounts may result in improved customer retention and a reduction in waiting times at the customer support center. However, bottom-of-the-line discounts cause significant loss of revenue over the long term because they are applied in whole-sale fashion to all services received by a subscriber and without regard to the specific needs of the subscriber.

The use of bottom-of-the-line discounts is partly a result of the complexity of analyzing each possible modification to an existing service account. Inexperienced customer service representatives often lack the knowledge or training to judge whether a particular modification to a subscriber's existing services will lead to a price reduction. Furthermore, MRC information may not be readily available unless the customer service representative actually enters an order for a service at the CRM application. Thus, customer service representatives may create and cancel service orders simply to determine the potential savings of a particular modification to a current subscription. The complexity and delay caused by such an ad-hoc method of delivering cost savings to a subscriber causes frustration on the part of the subscriber and reluctance on the part of the customer service representatives to perform such analyses. As a result, customer service representatives are prone to over-utilizing bottom-of-the-line discounts in order to retain unhappy subscribers. Supervisors are unable to control the use of these discounts because they are unable and sometimes unwilling to monitor each customer interaction in detail. In addition, the desire for efficient customer support center operations may conflict with detailed monitoring because supervisors are under pressure to reduce waiting times. The long-term gain of training inexperienced customer service representatives is outweighed by the short-term efficiency gains produced by bottom-of-the-line discounts.

To address these problems, the system 100 utilizes the account options platform 115 to implement a set of rules for reducing and managing the revenue leak associated with bottom-of-the-line discounts. This may be achieved by a method including retrieving a current account option selected by a subscriber for a service account, applying a rule to determine a recommended account option for reducing a cost for the service account, and generating a customer service user interface for presenting at least one of: cost comparison information for the current account option and the recommended account option, a control element for ordering the recommended account option, and information for discussing the recommended account option with the subscriber.

In one embodiment, the account options platform 115 causes the retrieval of the current account option when a customer service representative is interacting with a GUI of a CRM application. For example, a subscriber may be calling to discuss an increase in the monthly charges as reflected in a recent notice in a mailed statement. Alternatively, the subscriber may simply be calling because he or she may have questions about the charges as reflected in the latest billing statement. In one embodiment, the account options platform 115 applies a rule to the retrieved current account information to determine one or more recommended account options for the subscriber. Possible account cost scenarios and associated contract terms may be dynamically updated at the CRM application while the service account is being discussed with the subscriber. The account options platform 115 may analyze the current account option to determine possible service upgrades, discounts, promotions, and various price or feature incentives. In one embodiment, the account options platform 115 may utilize marketing information developed by the service provider to aid in the determination of possible upgrade and renewal options, right-sizing options, or loyalty offer options. Next, in one embodiment, the account options platform 115 may present a cost comparison between the current account option and the recommended account option, a control button to select a recommended account option, and information for discussing the recommended account option. The account options platform 115 may categorize, sort, and arrange the presentation of this information such that it can be easily understood and readily applied by even an inexperienced customer service representative.

As used herein, the term “upgrade” may be used to refer to the addition of services to a subscriber's service account. Such services may include, for instance, added voice, video, and data services as well as third-party services. For instance, an upgrade may involve increasing the amount of data (e.g., Megabits of data) or the speed of access (e.g., in terms of megabits per second (Mbps)) for a particular service. It is contemplated that the service provider may also create various upgrade or renewal packages based on collections of upgraded features. In one embodiment, an upgrade may include upgrades to customer premise equipment leased to the subscriber by the service provider. It may also include upgrades to third-party services delivered via the service provider. An upgrade option may also include an option to renew one or more existing services for an additional one or more renewal periods.

As used herein, the term “right-sizing” may be used to refer to one or more modifications to an existing service configuration that results in a reduction of an account cost. For example, a subscriber may have an existing service that provides unlimited voice, video, and data service at a highest level of quality (e.g., high-definition video). However, the subscriber may not be an avid television viewer and may be willing to accept a lower quality service for a reduced cost. The CRM application may be caused to display one or more alternative voice, video and data bundles that only include limited quality video at a lower MRC. Right-sizing may also be used to refer to modifications to third-party services. For example, a subscriber may be currently subscribed to receive content from one or more third-party content providers (e.g., content provider 117), but may not have the time to view the content. In such situations, the CRM application may be caused to display alternative service packages that have fewer features for a reduced cost.

In one embodiment, the account options platform 115 may generate a customer service user interface for presenting at least one of: cost comparison information for the current account option and the recommended account option, a control element for ordering the recommended account option, and information for discussing the recommended account option with the subscriber. For example, the account options platform 115 may cause the customer support terminal 121 to generate a GUI of a CRM application the customer service representative is interacting with. In one embodiment, the GUI is a windows-based multi-document interface (e.g., tabs) that allows navigation between different sections of the subscriber's account information. In one embodiment, the customer service user interface may include MRC information associated with a subscriber's current account option and a difference with a recommended account option. In one embodiment, the customer service interface may also include a control button to invoke an order entry process if a recommended account option is selected. In one embodiment, the GUI may also include scripts for presenting the recommended account option or to discuss the existing account options with the subscriber. For instance, a script may provide a customized recitation of account options that the customer service representative can read off the customer support terminal 121.

The rule may specify a sequence to present the upgrade and renewal option, the right-sizing option, or the loyalty offer option in the customer service user interface. In one embodiment, the account options platform 115 applies the rule to the presentation of the current account option and the recommended account option at a GUI of a CRM application executing at the customer support terminal 121. A customer service representative may be requested to input acknowledgment to move forward in the sequence. For instance, the account options platform 115 may cause the CRM application to generate a dialog box that requires an acknowledgment input from the customer service representative.

The upgrade and renewal option may be presented in the customer service user interface and an acknowledgment input may be requested from the customer service representative interacting with the customer service user interface before advancing to the right-sizing option. In one embodiment, the account options platform 115 causes the CRM application to generate a dialog box requesting an acknowledgment input from the customer service representative to confirm that the representative has discussed the upgrade and renewal option. Only after the acknowledgment input has been received will the CRM application allow the customer service representative to navigate to the right-sizing option.

The right-sizing option may be displayed in the customer service user interface and an acknowledgment input may be requested from the customer service representative interacting with the customer service user interface before advancing to the loyalty offer option. In one embodiment, the account options platform 115 causes the CRM application to generate a dialog box requesting an acknowledgment input from the customer service representative to confirm that the representative has discussed the right-sizing option. In one embodiment, the account options platform 115 may cause the CRM application to display a modal dialog box requesting verification that the right-sizing account options have been discussed with the subscriber. (As used herein, “modal dialog box” may be used to refer to any dialog box that prevents further interaction with the application until it is dismissed by the user.) For example, the customer service representative may be required to dismiss the dialog box before allowing further interaction with the CRM application to navigate to a tabbed section of the user interface for loyalty offers.

The method may further include determining whether a customer service representative interacting with the customer service user interface has discussed the recommended account option with the subscriber based on a duration of a time period for which the recommended account option has been presented at the customer service user interface. In one embodiment, the account options platform 115 may determine how long the recommended account option has been displayed at the CRM application displayed at the customer support terminal 121. The account options platform 115 may determine that the customer service representative has not discussed the presented account options if the duration for which they have been presented is less than a threshold value (e.g., ten seconds). If the duration is less than a threshold value, the method may further include determining that the recommended account option has not been discussed and sending a notification message. For instance, the account options platform 115 may determine to send a notification message to a supervisor. The supervisor's contact information may be determined based on the logon credentials of the customer service representative and an employee profile associated with the logon credentials.

The method may further include determining a current account cost of the customer account, determining to dynamically update a tentative account cost based on the recommended account option, and determining to dynamically update an account cost savings based on a difference between the current account cost and the tentative account cost. In one embodiment, the account options platform 115 may determine the current account cost based on the subscriber's MRC. The account options platform 115 may retrieve the MRC information from the subscriber database 123. In one embodiment, the account options platform 115 may dynamically update the tentative account cost based on the recommended account option (taking into consideration discounts, promotions and loyalty offers). For example, the tentative account cost may be displayed and dynamically updated as the customer service representative makes one or more preliminary selections of the recommended account option at the GUI of the CRM application. Similarly, the difference between the current account cost and the tentative account cost may be dynamically updated as an increase or decrease of the subscriber's current MRC.

As used herein, the term “tentative account cost” may be used to refer to an MRC or account cost based on one or more account options selected, but not ordered, by a customer service representative. The account options platform 115 may dynamically update an account cost savings based on the difference between the first account cost and the second account cost. For example, the account cost savings may be generated based on the account options and displayed alongside the second account cost. In one embodiment, the tentative account cost and the account savings may be clearly displayed at the user interface of the CRM application that the customer service representative is interacting with.

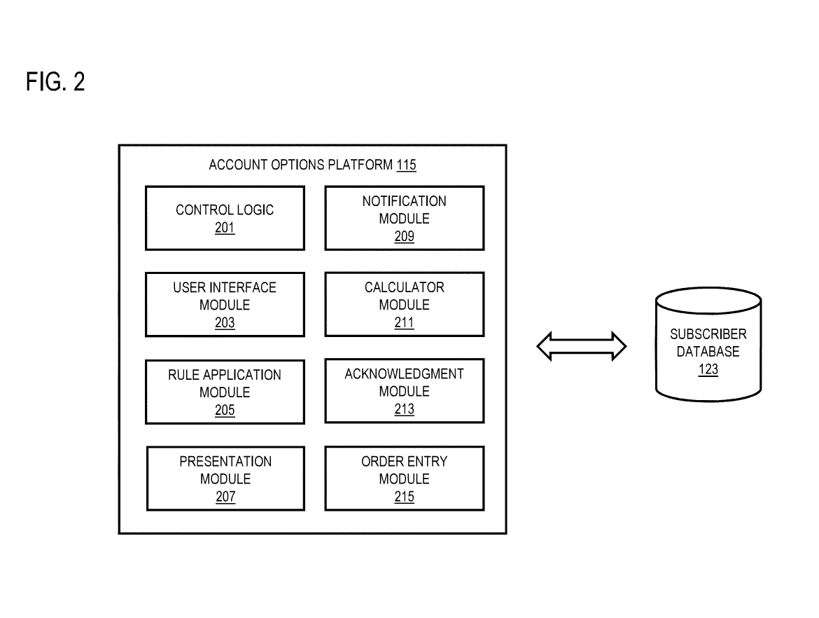

FIG. 2 is a diagram of the components of the account options platform 115, according to an exemplary embodiment. By way of example, the account options platform 115 includes one or more components for providing account options management services. It is contemplated that the functions of these components may be combined in one or more components or performed by other components of equivalent functionality. In this embodiment, the account options platform 115 includes control logic 201, a user interface module 203, a rule application module 205, a presentation module 207, a notification module 209, a calculator module 211, an acknowledgment module 213, and an order entry module 215.

Control logic 201 may provide the logic for executing one or more processes and storing information that is created by the various modules in the subscriber database 123. In one embodiment, the subscriber database 123 contains the profile, billing, current account option, and recommended account option information for a subscriber. It is contemplated that the subscriber database 123 may encompass any form of facility for the systematic storage and retrieval of all or a portion of the information related to the service provider's customers. The information may include current and historical subscriber data that may be utilized to determine a recommended account option and to assist the customer service representative to better understand the needs and concerns of a particular subscriber. In one embodiment, control logic 201 receives input from the CRM application and retrieves information related to a particular subscriber from the subscriber database 123. Processed data may be stored in the subscriber database 123 or caused to be presented at the CRM application the customer service representative is interacting with.

Control logic 201 may utilize the user interface module 203 to generate and update a customer service user interface for presenting current and recommended account options. In one embodiment, the user interface module 203 may control the presentation of information at the CRM application by monitoring the input at the customer support terminal 121. Based on the input, the user interface module 203 may cause the presentation of a particular recommended account option, including an upgrade and renewal option, a right-sizing option, or a loyalty offer option. In one embodiment, the user interface module 203 interacts with the rule application module 205, presentation module 207, calculator module 211, acknowledgment module 213, and order entry module 215 to update the CRM application.

Control logic 201 may utilize the rule application module 205 to control the presentation of service account information, including a current account option and a recommended account option. In one embodiment, the rule application module 205 is utilized to determine a recommended account option based on marketing information related to the particular subscriber the customer service representative is talking to. The marketing information may be contained, for instance, in a subscriber profile stored in the subscriber database 123. For example, a subscriber may be eligible for an upgrade, right-sizing, or loyalty offer based on the duration of the subscriber's contract or number the of services that the subscriber is subscribed to. In one embodiment, the rule application module 205 is utilized to determine the sequence in which one or more recommended account options are presented at the CRM application. For instance, the user interface module 203 may invoke the rule application module 205 to apply a rule specifying the sequence for the presentation of an upgrade and renewal option, a right-sizing option, or a loyalty offer option. In one embodiment, the rule application module 205 causes the presentation module 207 to present an upgrade and renewal account option first. Depending on the availability of a recommended account option, the rule application module 205 may alter or modify the sequence of the presentation. For instance, if there are no upgrade or renewal account options available to a particular subscriber, the rule application module 205 may cause the presentation module 207 to first present a right-sizing account option (if available).

Control logic 201 may utilize the presentation module 207 to present account information generated by the rule application module 205. In one embodiment, the presentation module 207 causes a customer service user interface of a CRM application to update with the current account and recommended account option generated by the rule application module 205. For example, the presentation module 207 may control one or more GUI controls or document interfaces of the CRM application based on the generated account information. The presentation module 207 may be utilized to also cause the presentation of various navigation controls. In one embodiment, the navigation controls are GUI controls that operate to implement the rules of the rule application module 205. For instance, the GUI controls may include buttons allowing selection of a recommended account option or navigation to a particular tab (e.g., right-sizing tab, loyalty offer tab). The presentation module 207 may also cause the CRM application to present a selection button (or other GUI control) for invoking an order entry process. The presentation module 207 may also cause the CRM application to present a selection button to discard any selected account options and to allow navigation to a different account option.

Control logic 201 may utilize the notification module 209 to send a notification message to a supervisor or manager responsible for CRM. In one embodiment, the notification module 209 provides supervisors a facility for delivering RTC to their customer service representatives. As previously described, some customer service representatives may not be very experienced or may lack training in CRM and negotiation. Customer service representatives may occasionally be tempted to skip past upgrade and right-sizing account options to loyalty offers (e.g., if the customer is impatient or indicates that he or she is unwilling to continue a subscription unless provided a discount). In one embodiment, the notification module 209 may alert a supervisor if the CRM application indicates that a subscriber is about to receive or has received a bottom-of-the-line discount. For example, the account options platform 115 may detect if a customer service representative is attempting to navigate away from an upgrade and renewal tab or a right-sizing tab of the CRM application without having entered an order.

The account options platform 115 may also alert the supervisor if the amount of time spent with the customer was below a threshold value (e.g., ten seconds). In one embodiment, the account options platform 115 may cause a supervisor to be automatically notified with the customer service representative's contact information. The supervisor may thereafter discuss the particular subscriber's account with the customer service representative in order to coach the representative. In one embodiment, the notification module 209 may notify a supervisor that one or more specific account options were not discussed with a subscriber.

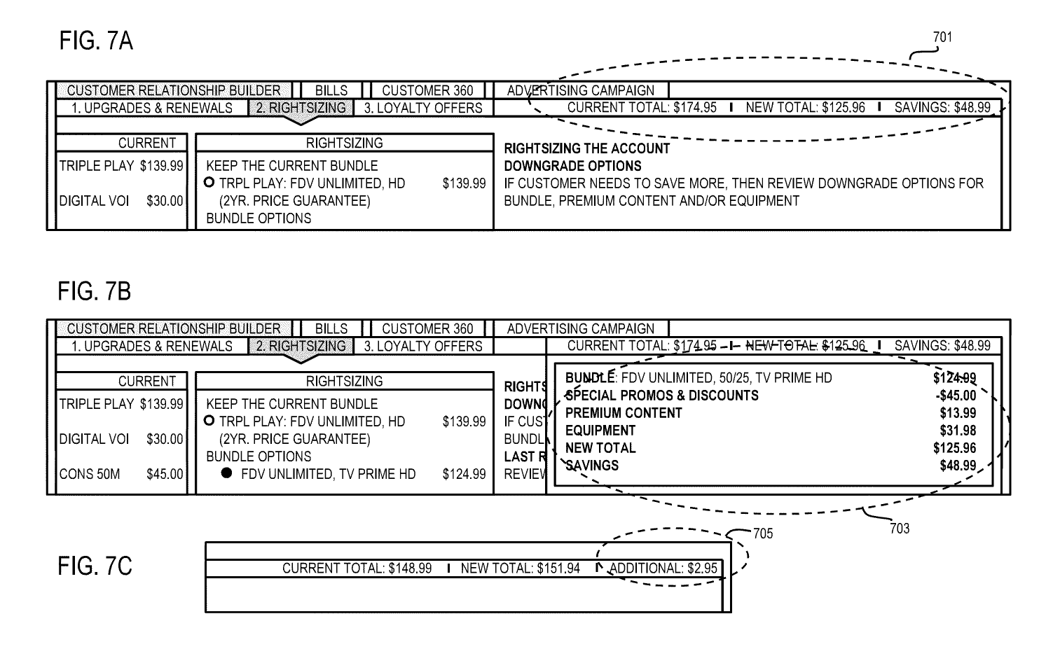

Control logic 201 may utilize the calculator module 211 to determine and dynamically update a tentative account cost based on a recommended account option. Control logic 201 may, for instance, cause the presentation module 207 to present an upgrade and renewal option, a right-sizing option, and a loyalty offer option at the CRM application. In one embodiment, the calculator module 211 may dynamically update the tentative cost of the recommended account option that is being currently displayed at the CRM application while the customer service representative discusses it with the subscriber. The CRM application may present the tentative account cost, the current account cost, and the difference between the costs as either a savings or an additional cost. In one embodiment, the calculator module 211 may cause the presentation module 207 to utilize various coloring schemes (e.g., blue color to indicate a savings and red color to indicate an additional cost) when presenting the cost information. The calculator module 211 may also dynamically update any sub-totals associated with a recommended account option (e.g., third-party premium content costs, equipment costs, etc.). In one embodiment, the calculator module 211 causes the presentation module 207 to display an itemized summary of the dynamically generated calculations when the customer service representative moves a mouse or other computer-aided display control over an account cost display at the CRM application. For example, and as further described with respect to FIGS. 7A through 7C, a top portion of the customer service user interface may list a “CURRENT TOTAL” (based on the current account cost), a “NEW TOTAL” (based on selected recommended account option), and a “SAVINGS” (the difference between the “CURRENT TOTAL” and the “NEW TOTAL”). The itemized summary may also display the name of any service package, promotions, or other features of the package. The itemized summary may include a separate line detailing the costs attributable to third-party services.

Control logic 201 may utilize the acknowledgment module 213 to request an acknowledgment from a customer service representative interacting with a CRM application. In one embodiment, the acknowledgment module 213 causes the CRM application to generate a modal dialog box and require a response from the customer service representative. The CRM application may be caused to generate the acknowledgment request if the customer service representative attempts to navigate within the CRM application without saving or ordering a selected account option. For example, the customer service representative may have selected (e.g., via a selection GUI control such as a radio button or check box) a recommended account option (e.g., a particular voice, video and data package) while discussing an upgrade and renewal option with the customer. However, the customer service representative may be attempting to navigate away from the displayed interface without having invoked an order entry process for the selected option. In one embodiment, the acknowledgment module 213 may determine that the selected account option is about to be lost (e.g., from cache memory) and, therefore, generate a dialog box to confirm the customer service representative's action. It is contemplated that the acknowledgment module 213 may request an acknowledgment input whenever the customer service representative attempts to advance through the account options without saving them as part of an ordering process. In one embodiment, the acknowledgment module 213 may request an acknowledgment if the customer service representative attempts to select a right-sizing or a loyalty offer option without having ordered a selected renewal and upgrade option. Similarly, the acknowledgment module 213 may request an acknowledgment input if the customer service representative attempts to select a loyalty offer option without ordering a selected right-sizing option.

Control logic 201 may utilize the order entry module 215 to initiate an order for a selected account option. In one embodiment, an order entry process may be invoked by clicking or otherwise selecting a control button on the GUI interface of the CRM application that a customer service representative is interacting with. For instance, a customer service representative may select a recommended account option via a selection GUI control. If the subscriber agrees with the selected account option, the customer service representative may begin the order entry process by next clicking or otherwise selecting another GUI control (e.g., button or other control that may be selected to perform an action). In one embodiment, the invoked order entry process executes as an independent process at the account options platform 115. It is contemplated that the account options platform 115 may receive the details of the order from the CRM application and forwards it to a separate order entry system (not shown). In one embodiment, the order entry module 215 may cause the CRM application to suspend user control while the order is processed. Once the order has been processed, the order entry module 215 may cause control of the CRM application to return to the last tab or other user interface the customer service representative was interacting with.

In one embodiment, the order entry module 215 may be utilized to enter more than one order at the same time. For example, the customer service representative may discuss an upgrade option and a right-sizing option with the subscriber. Based on the discussion, the subscriber may want to upgrade certain account services (e.g., voice, video, or data services) while right-sizing certain other services (e.g., content or equipment packages). In one embodiment, the order entry module 215 may save an account option selected during a particular session with a subscriber. If the subscriber agrees to the selected account option at some later point or different session, the order entry module 215 may be utilized to simultaneously submit all selected account options to an order entry process.

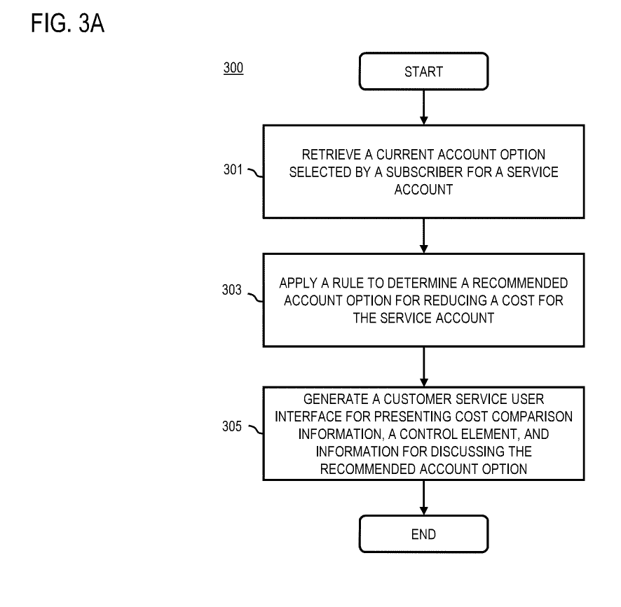

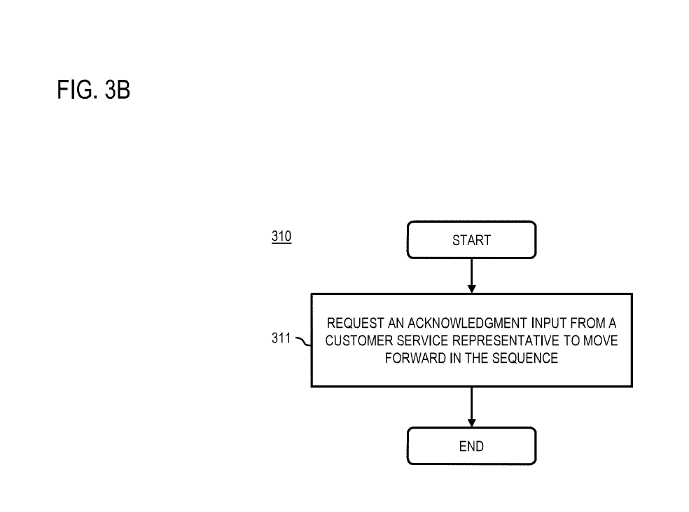

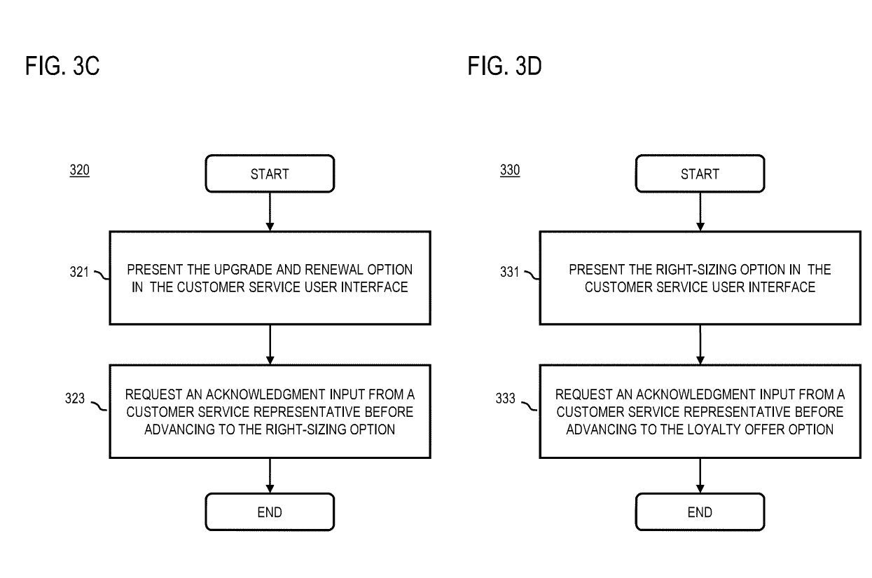

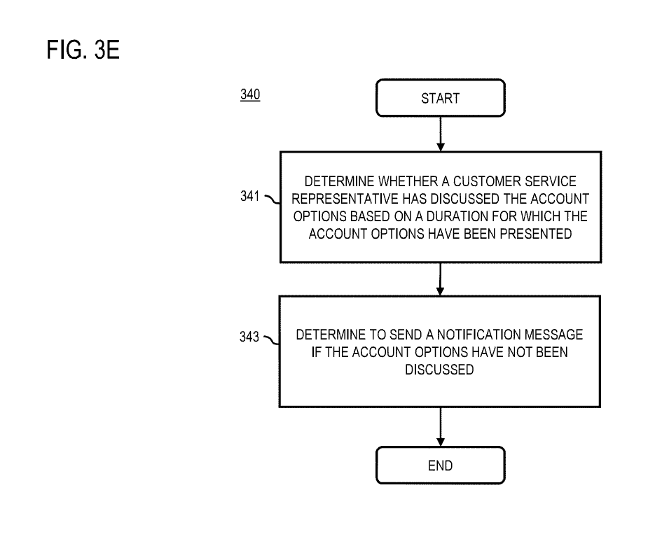

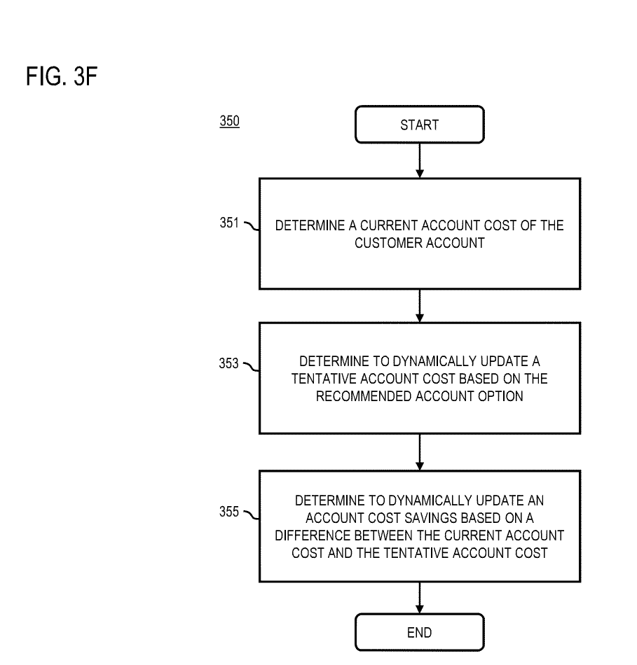

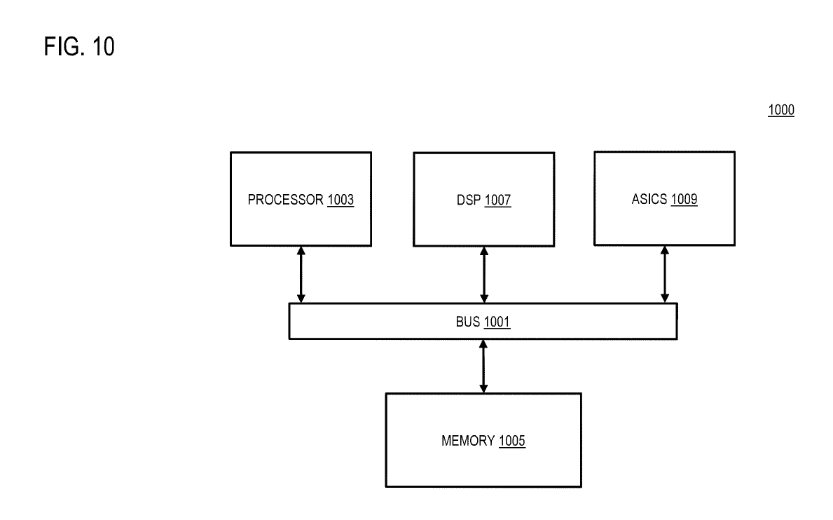

FIGS. 3A through 3F illustrate flowcharts for managing account options, according to an exemplary embodiment. In one embodiment, the account options platform 115 performs the processes illustrated in FIGS. 3A through 3F and are implemented in, for instance, a chip set including a processor and a memory as shown in FIG. 10.

FIG. 3A illustrates a flowchart for a process 300 for managing account options, according to an exemplary embodiment. In step 301, control logic 201 retrieves from the subscriber database 123 a current account option selected by a subscriber for a service account. In one embodiment, control logic 201 causes the retrieval of the current account option in response to an inquiry from a subscriber about a service account. For example, the subscriber may be calling to discuss an increase in the monthly charges as reflected in a recent notice in a mailed statement. Alternatively, the subscriber may simply be calling because he or she may have questions about the charges as reflected in the latest billing statement.

In step 303, control logic 201 utilizes the rule application module 205 to apply a rule to determine a recommended account option for reducing a cost for the service account. For example, the rule application module 205 analyzes the retrieved current account option in step 301 and available account options to determine a recommended account option. The rules may, for instance, generate an upgrade and renewal option, a right-sizing option, or a loyalty offer option. In one embodiment, the rule application module 205 may also analyze marketing information produced by the service provider. Such information may include, for example, specially priced services, discounts, add-ons, promotional sales, etc. In one embodiment, the marketing information may also be stored in the subscriber database 123.

In one embodiment, the rule determined by the rule application module 205 may specify a sequence for presenting the upgrade and renewal option, the right-sizing option, or the loyalty offer option in the customer service user interface. For instance, the rule application module 205 may create a display sequence to control the presentation of the account options via the presentation module 207. In one embodiment, the sequence may require the upgrade and renewal option to be presented first, the right-sizing option to be presented second, and the loyalty offer option to be presented third. In one embodiment, the upgrade and renewal option may be presented in a first tab of a MDI page of the CRM application and the right-sizing option and loyalty offer option may be presented in respective second and third tabs of the CRM application's GUI.

In step 305, control logic 201 may utilize the user interface module 203, presentation module 207, and calculator module 211 to generate a customer service user interface for presenting cost comparison information, a control element, and information for discussing the recommended account option. In one embodiment, the presentation module 207 takes the information generated by the rule application module 205 and formats it according to the GUI of the CRM application the customer service representative is interacting with. In addition, the presentation module 207 utilizes the calculator module 211 to determine the current account cost and a cost comparison based on the recommended account option.

FIG. 3B illustrates a flowchart for a process 310 for managing account options, according to an exemplary embodiment. In step 311, the acknowledgment module 213 causes the CRM application to request an acknowledgment input from the customer service representative to move forward in the sequence. In one embodiment, the acknowledgment module 213 determines that the customer service representative is attempting to navigate away from a MDI document tab and causes the user interface module 203 to generate a modal dialog box requesting acknowledgment input from the customer representative. For example, the dialog box may ask the customer service representative to confirm that any selections made in the current tab will be lost. If the requested acknowledgment input is received, the user interface module 203 is utilized to display a different tab. In one embodiment, the CRM application may be caused to seek the acknowledgment input when advancing from the upgrade and renewal option to the right-sizing option, the upgrade and renewal option to the loyalty offer option, or the right-sizing option to the loyalty offer option.

FIG. 3C illustrates a flowchart for a process 320 for managing account options, according to an exemplary embodiment. In step 321, control logic 201 utilizes the presentation module 207 to present the upgrade and renewal option in the customer service user interface. In one embodiment, the presentation module 207 causes the display of the upgrade and renewal option generated for the subscriber by the rule application module 205. In one embodiment, the upgrade and renewal option has been generated based on the services the subscriber is currently receiving. Various other factors may include, for example, the subscriber's location (e.g., zip code) to determine availability of services, term of contract (e.g., a long-term contract compared to a month-to-month contract), and the current of services that the subscriber is receiving. In step 323, the acknowledgment module 213 may request an acknowledgment input from a customer service representative before advancing to the right-sizing option. In one embodiment, the acknowledgment module 213 may utilize the presentation module 207 to cause the CRM application to display a modal dialog box requesting the acknowledgment input. The customer service representative may only be allowed to advance to a right-sizing or loyalty offers tab if the customer service representative acknowledges the request.

FIG. 3D illustrates a flowchart for a process 330 for managing account options, according to an exemplary embodiment. In step 331, control logic 201 utilizes the presentation module 207 to present the right-sizing option in the customer service user interface. In one embodiment, the presentation module 207 causes the display of the right-sizing option generated for the subscriber by the rule application module 205. In one embodiment, the right-sizing option has been generated by the rule application module 205 based on the services the subscriber is currently receiving. Various other factors may include, for example, the subscriber's location (e.g., zip code) to determine availability of services, term of contract (e.g., a long-term contract compared to a month-to-month contract), and the current of services that the subscriber is receiving. In step 333, the acknowledgment module 213 may request an acknowledgment input from a customer service representative before advancing to the loyalty offer option. In one embodiment, the acknowledgment module 213 may utilize the presentation module 207 to cause the CRM application to display a modal dialog box requesting the acknowledgment input. The customer service representative may only be allowed to advance to a right-sizing or loyalty offers tab if the customer service representative acknowledges the request.

FIG. 3E illustrates a flowchart for a process 340 for managing account options, according to an exemplary embodiment. In step 341, control logic 201 may utilize the notification module 209 to determine whether a customer service representative has discussed the account options based on a duration for which the account options have been presented. In one embodiment, the notification module 209 may monitor the session duration for a particular account option at the CRM application. The notification module may, for instance, determine that the recommended account option has not been discussed if the customer service representative attempts to navigate away from the presented account option before a certain pre-specified amount of time has elapsed. In one embodiment, the recommended account option may have been presented in an active tab of a MDI GUI. The notification module 209 may determine the amount of time the recommended account option has been displayed when the active tab changes. The notification module 209 may determine that the recommended account option was not discussed if the amount of time the active tab was displayed is below a threshold value (e.g., ten seconds).

FIG. 3F illustrates a flowchart for a process 350 for managing account options, according to an exemplary embodiment. In step 351, control logic 201 utilizes the calculator module 211 determines a current account cost of the customer account. The calculator module 211 may access the subscriber database 123 to retrieve the MRC of the service account. In step 353, the calculator module 211 may dynamically update a tentative account cost based on the recommended account option. In one embodiment, the calculator module 211 determines the tentative account cost based on a recommended account option selected by the customer service representative. In one embodiment, the calculator module 211 may also cause the presentation module 207 to dynamically update the customer service user interface of the CRM application to present the tentative account cost, including associated itemized charges of the recommended account option. In step 355, the calculator module 211 determines to dynamically update an account cost savings based on a difference between the current account cost and the tentative account cost. In one embodiment, the calculator module 211 may also cause the presentation module 207 to dynamically update the customer service user interface of the CRM application to present the cost savings.

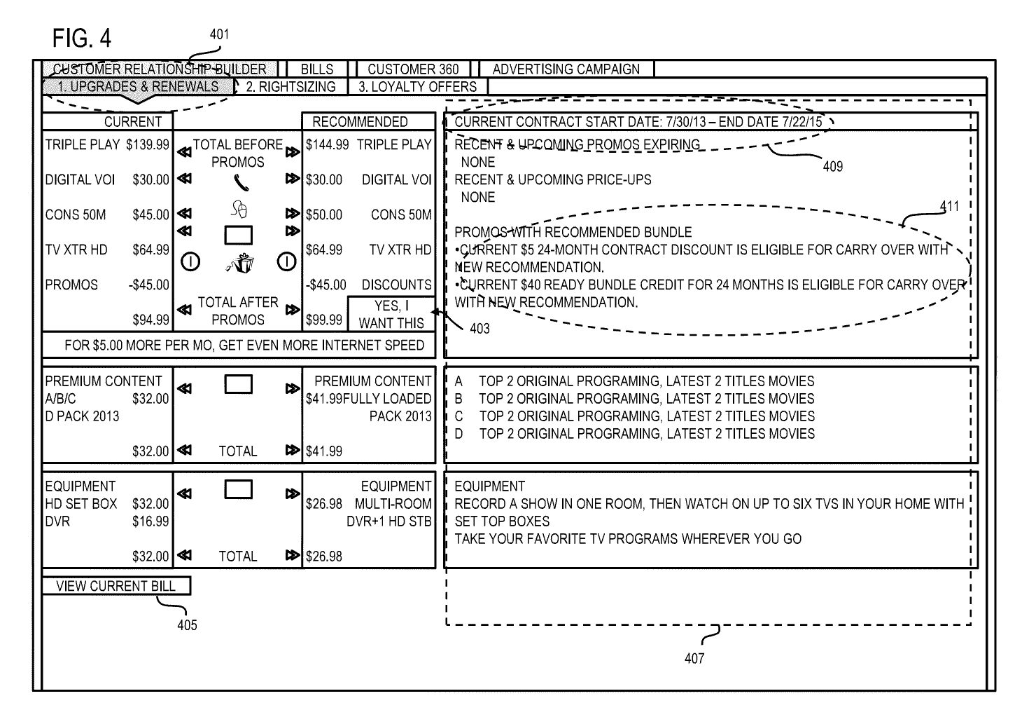

FIG. 4 illustrates an upgrade and renewal tab 401 in a MDI of a CRM application, according to an exemplary embodiment. In one embodiment, upgrade and renewal option may be presented alongside the services that the subscriber is already subscribed to. The side-by-side presentation may assist the customer service representative because it provides a clear comparison of the current account option and a recommended account option. As shown, the upgrade and renewal tab 401 (“UPGRADES & RENEWALS”) is the active tab in the MDI of the CRM application. As further shown, the left side of the upgrade and renewal tab 401 includes the current (“CURRENT”) and recommended (“RECOMMENDED”) account option for various categories of voice, video, data services (e.g., “TRIPLE PLAY”), content offerings (e.g., “PREMIUM CONTENT”), and equipment (“EQUIPMENT”). The cost of the account options is displayed alongside each current and recommended account option for easy comparison. In one embodiment, the tab may also display control button to invoke an order entry process. For example, a recommended account option may be ordered by depressing the button GUI control 403 “YES, I WANT THIS.” The upgrade and renewal tab 401 may also display a button GUI control 405 to generate and display the customer's latest billing statement (e.g., “VIEW CURRENT BILL”).

In one embodiment, additional information 407 may be presented on a right side of the active tab. The additional information 407 may include, among other things, information for discussing a recommended account option with the subscriber. For example, if the subscriber is under a contract (instead of a month-to-month agreement), the right side of the upgrade and renewal tab 401 may present the dates 409 for which the contract is valid (“CURRENT CONTRACT . . . ”). The additional information 407 may include various renewal options and promotions (e.g., promotions 411) that the subscriber may be eligible to receive. For example, any promotions that the subscriber is currently receiving may be rolled over into the recommended upgrade and renewal option. In one embodiment, the additional information 407 regarding the subscriber's account options may be dynamically generated based on marketing information developed and stored in the subscriber database 123. In one embodiment, the additional information 407 may be regularly updated at the account options platform 115 and formatted for presentation at the CRM application when the customer calls.

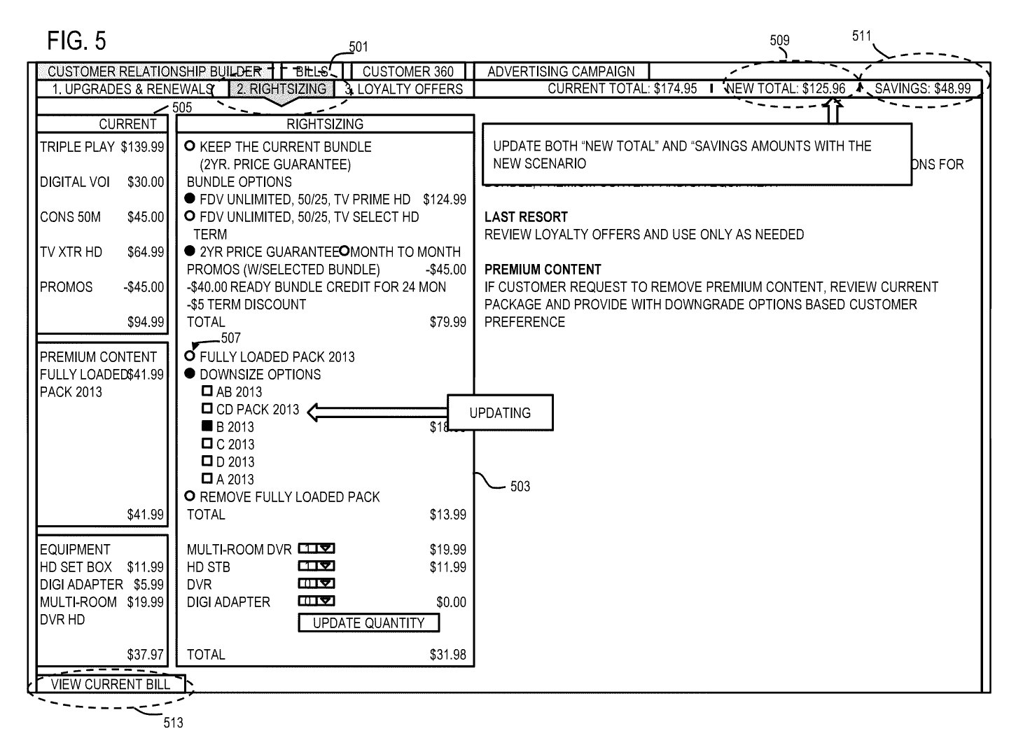

FIG. 5 illustrates a right-sizing tab 501 of a CRM application, according to an exemplary embodiment. In one embodiment, a right-sizing option 503 may be presented alongside the services 505 that the subscriber is already receiving. The side-by-side presentation assists the customer service representative by providing a clear comparison of a current and recommended account option. As shown, the right-sizing tab 501 (“RIGHTSIZING”) is the active tab in the MDI of the CRM application. As further shown, the left side of the right-sizing tab 501 includes a current (“CURRENT”) and a right-sized (“RIGHTSIZING”) option for voice, video, data services (e.g., “TRIPLE PLAY”), content offerings (e.g., “PREMIUM CONTENT”), and equipment (“EQUIPMENT”). The cost is displayed alongside each current and recommended option for easy comparison. As shown, radio buttons (e.g., radio button 507) are displayed alongside the right-sizing options to select among them. Based on the selection, a tentative account cost 509 (“NEW TOTAL”) may be dynamically updated. In one embodiment, the tentative account cost 509 and the account cost savings 511 (“SAVINGS”) are dynamically updated as the selections are made. Like the upgrade and renewal tab 401, the right-sizing tab 501 may display a control GUI button 513 to generate and display the customer's latest billing statement (e.g., “VIEW CURRENT BILL”).

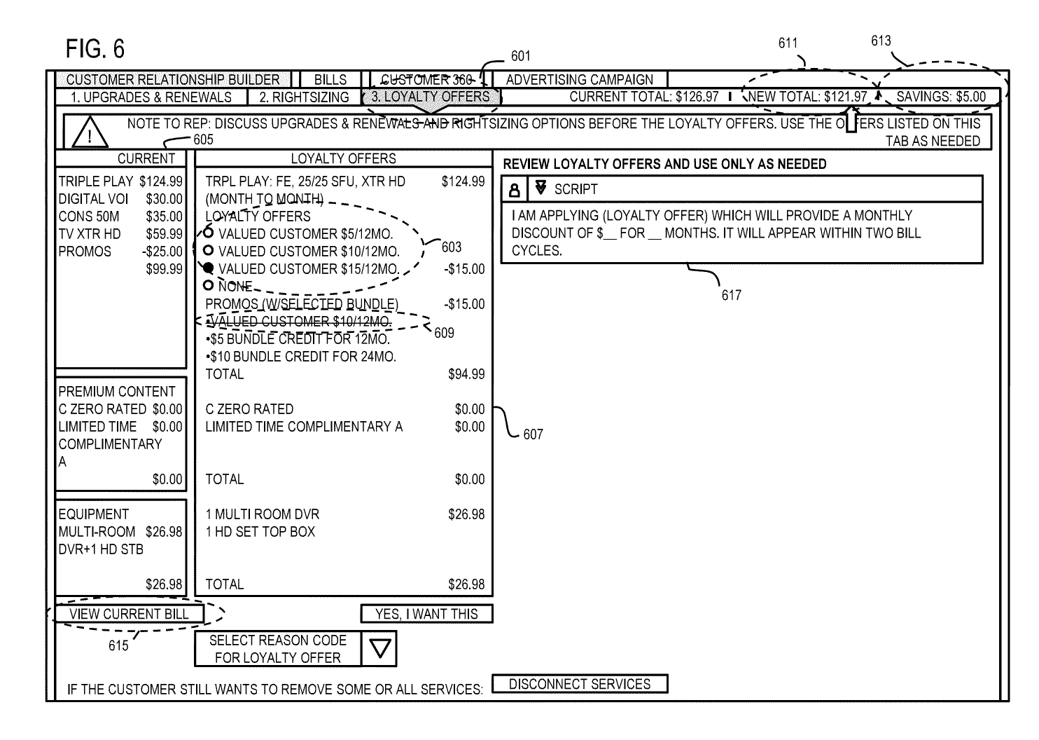

FIG. 6 illustrates a loyalty offer tab 601 of a CRM application, according to an exemplary embodiment. In one embodiment, the loyalty offers 603 may be presented alongside the services that the subscriber is already receiving. The side-by-side presentation assists the customer service representative by providing a clear comparison between the existing services and any applicable loyalty offers. As shown, the loyalty offers tab 601 (“LOYALTY OFFERS”) is the active tab in the MDI of the CRM application. As further shown, the left side of the loyalty offers tab 601 includes the current services 605 (“CURRENT”) and the loyalty offers 607 (“LOYALTY OFFERS”) for voice, video, data services (e.g., “TRIPLE PLAY”), content offerings (e.g., “PREMIUM CONTENT”), and equipment (e.g., “1 MULTI ROOM DVR”). In one embodiment, the loyalty offers (e.g., loyalty offer option 603) are bottom-of-the-line discounts applied to one or more of the services the subscriber is currently receiving. As shown, for instance, the loyalty offers 603 indicate that the TRIPLE PLAY voice, video and data package may be discounted by five dollars for twelve months (“$5/12MO”), ten dollars for twelve months (“$10/12MO”), or fifteen dollars for twelve months (“$15/12MO”). The loyalty offers tab 601 may also update the list of available loyalty offers by clearly indicating any loyalty offers added or removed. In the example scenario illustrated, the selection of the fifteen dollars for twelve months (“$15/12MO”) loyalty offer has resulted in the removal (as indicated by the line through the offer) of the ten dollars for twelve months (“$10/12MO”) loyalty offer 609.

A tentative account cost 611 (“NEW TOTAL”) may be dynamically updated. As shown, the tentative account cost 611 and the tentative cost savings 613 (“SAVINGS”) are updated as the selections are made. The loyalty offers tab 601 may also display a control button 615 to generate and display a latest billing statement (e.g., “VIEW CURRENT BILL”). In one embodiment, the CRM application may also present a guided script to assist the customer service representative when discussing the loyalty offer options. In the illustrated scenario of FIG. 6, for example, the CRM application may prompt the customer service representative to read the script 617 to the customer at the time the selected loyalty offers are being discussed.

FIGS. 7A through 7C illustrate an account cost display, according to an exemplary embodiment. As described above, the account options platform 115 may cause the CRM application to dynamically display account cost information associated with a recommended account option. In one embodiment, the account options platform 115 causes the CRM application to dynamically update the tentative account cost and cost savings based on a selected account option. As shown, the cost information is displayed in an upper right section 701. The display is dynamically updated as the customer service representative selects a recommended account option. An itemized summary of the tentative account costs for a selected option may be displayed in greater detail by moving a pointer (e.g., mouse) over the upper right section 701. FIG. 7B, for example, illustrates the itemized summary 703 of a tentative account cost based on the selected loyalty offer. If the selected account option (e.g., upgrade account option) results in an increase in account costs, the increase may be displayed instead. FIG. 7C, for example, illustrates an additional cost 705.

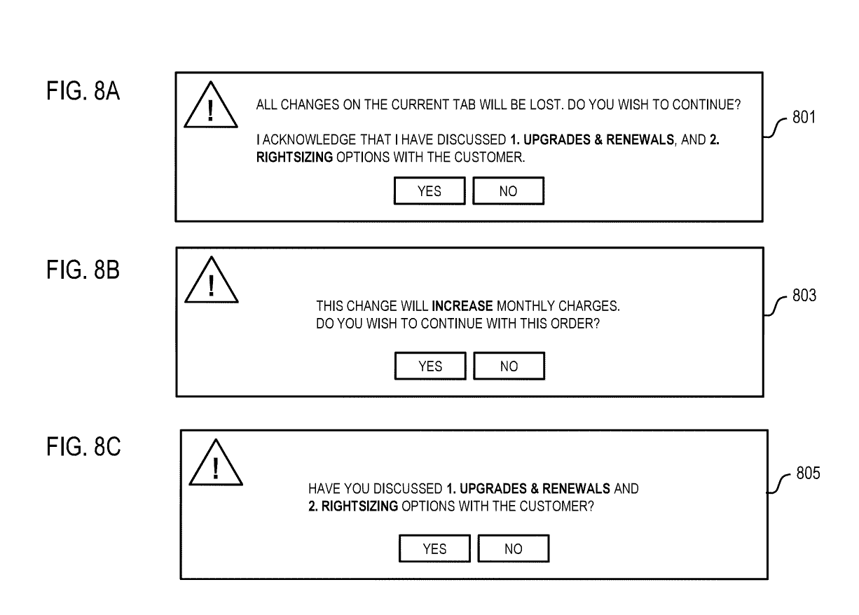

FIGS. 8A through 8C illustrate dialog boxes for obtaining acknowledgment input from a customer service representative, according to an exemplary embodiment. FIG. 8A illustrates a dialog box 801 requiring the customer service representative to acknowledge that he or she has discussed an upgrade and renewal option and a right-sizing option before advancing to a loyalty offer option. In one embodiment, the dialog box 801 is generated by the CRM application when the customer service representative attempts to switch focus of the active tab to the loyalty offers tab from the upgrade and renewal tab or right-sizing tab. As further shown, the dialog box 801 indicates that all changes to the right-sizing tab will be lost. In one embodiment, the dialog box 801 is generated because the customer service representative may have selected one or more account options on the current tab but did not initiate an order entry process prior to selecting on another tab.

FIG. 8B illustrates a modal dialog box 803 indicating that an account cost is about to increase. For example, a subscriber may have agreed to upgrade one or more services. The account options platform 115 may utilize the dialog box 803 to receive an acknowledgment input from the customer service representative that the subscriber agreed to the increased account cost associated with the upgraded services.

FIG. 8C illustrates a dialog box 805 requiring the customer service representative to acknowledge that he or she has discussed a possible upgrade and renewal option or right-sizing option before advancing to the loyalty discounts. In one embodiment, the dialog box 805 is generated by the CRM application when a customer service representative attempts to switch to the loyalty offers tab from a right-sizing tab. As further shown, the dialog box 805 indicates that all changes to the active right-sizing tab will be lost. In one embodiment, the dialog box 805 is generated because the customer service representative has selected a recommended account option on the active tab but has not initiated an order entry process.

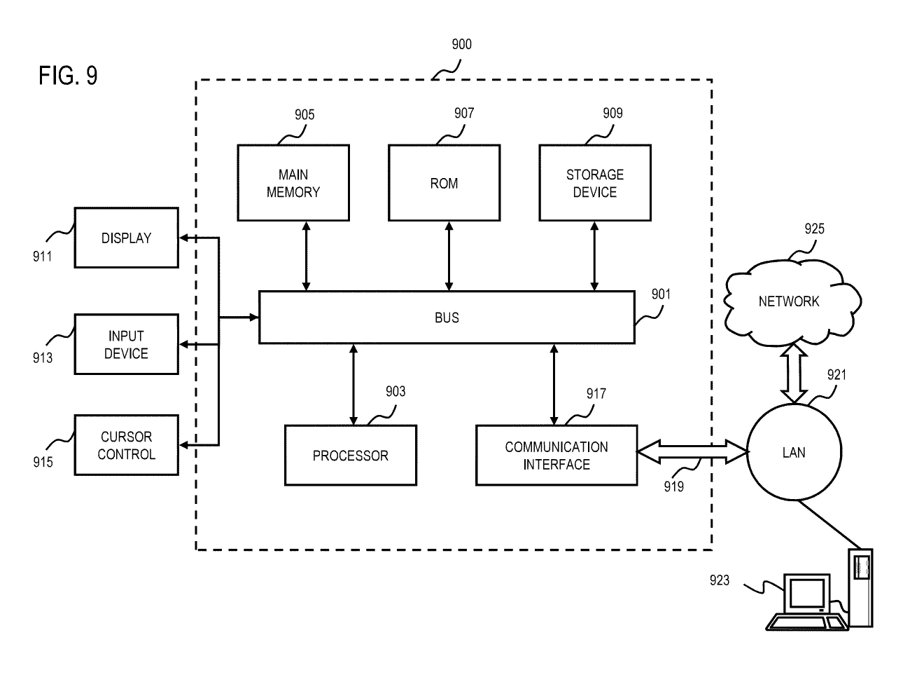

FIG. 9 illustrates computing hardware (e.g., computer system) upon which an embodiment according to the invention can be implemented. The computer system 900 includes a bus 901 or other communication mechanism for communicating information and a processor 903 coupled to the bus 901 for processing information. The computer system 900 also includes main memory 905, such as random access memory (RAM) or other dynamic storage device, coupled to the bus 901 for storing information and instructions to be executed by the processor 903. Main memory 905 also can be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multiprocessing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a DSL card or modem, ISDN card, a cable modem, a telephone modem, or any other communication interface to provide a data communication connection to a corresponding type of communication line. As another example, communication interface 917 may be a LAN card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a WAN or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a PDA or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 10 illustrates a chip set 1000 upon which an embodiment of the invention may be implemented. Chip set 1000 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of FIGS. 3A through 3F.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to perform specialized functions not easily performed by a general purpose processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
retrieving a current account option selected by a subscriber for a service account;
applying a rule to determine a recommended account option for reducing a cost for the service account, wherein the rule provides criteria for selecting the recommended account option from among an upgrade and renewal option, a right-sizing option, a loyalty offer option, or a combination thereof; and
generating a customer service user interface for presenting at least one of:
cost comparison information for the current account option and the recommended account option;
a control element for ordering the recommended account option; and
information for discussing the recommended account option with the subscriber.

2. The method of claim 1, wherein the rule specifies a sequence for presenting the upgrade and renewal option, the right-sizing option, the loyalty offer option, or a combination thereof in the customer service user interface.

3. The method of claim 2, further comprising:
requesting an acknowledgment input from a customer service representative to move forward in the sequence.

4. The method of claim 1, further comprising:
presenting the upgrade and renewal option in the customer service user interface; and
requesting an acknowledgment input from a customer service representative interacting with the customer service user interface before advancing to the right-sizing option.

5. The method of claim 1, further comprising:
presenting the right-sizing option in the customer service user interface; and
requesting an acknowledgment input from a customer service representative interacting with the customer service user interface before advancing to the loyalty offer option.

6. The method according to claim 1, further comprising:
determining whether a customer service representative interacting with the customer service user interface has discussed the recommended account option with the subscriber based on a duration of a time period for which the recommended account option has been presented at the customer service user interface.

7. The method according to claim 6, further comprising:
determining that the recommended account option has not been discussed if the duration is less than a threshold value; and
determining to send a notification message indicating that the recommended account option not been discussed.

8. The method according to claim 1, further comprising:
determining a current account cost of the customer account;
determining to dynamically update a tentative account cost based on the recommended account option; and
determining to dynamically update an account cost savings based on a difference between the current account cost and the tentative account cost.

9. An apparatus comprising at least one processor, the apparatus configured to:
retrieve a current account option selected by a subscriber for a service account;
apply a rule to determine a recommended account option for reducing a cost for the service account, wherein the rule provides criteria for selecting the recommended account option from among an upgrade and renewal option, a right-sizing option, a loyalty offer option, or a combination thereof; and
generate a customer service user interface for presenting at least one of:
cost comparison information for the current account option and the recommended account option;
a control element for ordering the recommended account option; and
information for discussing the recommended account option with the subscriber.

10. The apparatus according to claim 9, wherein the rule specifies a sequence for presenting the upgrade and renewal option, the right-sizing option, the loyalty offer option, or a combination thereof in the customer service user interface.

11. The apparatus according to claim 10, wherein the apparatus is further configured to:
request an acknowledgment input from a customer service representative to move forward in the sequence.

12. The apparatus according to claim 9, wherein the apparatus is further configured to:
present the upgrade and renewal option in the customer service user interface; and
request an acknowledgment input from a customer service representative interacting with the customer service user interface before advancing to the right-sizing option.

13. The apparatus according to claim 9, wherein the apparatus is further configured to:
present the right-sizing option in the customer service user interface; and
request an acknowledgment input from a customer service representative interacting with the customer service user interface before advancing to the loyalty offer option.

14. The apparatus according to claim 9, wherein the apparatus is further configured to:
determine whether a customer service representative interacting with the customer service user interface has discussed the recommended account option with the subscriber based on a duration of a time period for which the recommended account option has been presented at the customer service user interface.

15. The apparatus according to claim 14, wherein the apparatus is further configured to:
determine that the recommended account option has not been discussed if the duration is less than a threshold value; and
determine to send a notification message indicating that the recommended account option has not been discussed.

16. The apparatus according to claim 9, wherein the apparatus is further configured to:
determine a current account cost of the customer account;
determine to dynamically update a tentative account cost based on the recommended account option; and
determine to dynamically update an account cost savings based on a difference between the current account cost and the tentative account cost.

17. A system comprising:
a customer support terminal configured to execute a customer relationship management (CRM) application and
an account options platform configured to retrieve a current account option selected by a subscriber for a service account, apply a rule to determine a recommended account option for reducing a cost for the service account, wherein the rule provides criteria for selecting the recommended account option from among an upgrade and renewal option, a right-sizing option, a loyalty offer option, or a combination thereof, and generate a customer service user interface for presenting at the CRM application at least one of:
cost comparison information for the current account option and the recommended account option;
a control element for ordering the recommended account option; and
information for discussing the recommended account option with the subscriber.

18. The system according to claim 17, wherein the rule specifies a sequence for presenting the upgrade and renewal option, the right-sizing option, the loyalty offer option, or a combination thereof in the customer service user interface.

19. The system according to claim 17, wherein the account options platform is further configured to:
present the upgrade and renewal option in the customer service user interface; and
request an acknowledgment input from a customer service representative interacting with the customer service user interface before advancing to the right-sizing option.

20. The system according to claim 17, wherein the account options platform is further configured to:
present the right-sizing option in the customer service user interface; and
request an acknowledgment input from a customer service representative interacting with the customer service user interface before advancing to the loyalty offer option.
